(19) United States
(12) Patent Application Publication
(10) Pub. No.: US 2015/0093322 A1
(43) Pub. Date: Apr. 2, 2015

(54) METHOD FOR PURIFYING MULTI-WALLED CARBON NANOTUBES

(71) Applicant: SHOWA DENKO K.K., Minato, Tokyo (JP)

(72) Inventors: Ryuji Yamamoto, Tokyo (JP); Takeshi Nakamura, Tokyo (JP)

(73) Assignee: SHOWA DENKO K.K., Minato-ku, Tokyo (JP)

(21) Appl. No.: 14/396,539

(22) PCT Filed: Apr. 26, 2013
(86) PCT No.: PCT/JP2013/002840

§ 371 Date: Oct. 23, 2014

(30) Foreign Application Priority Data
Apr. 27, 2012 (JP) 2012-102657

(51) Int. Cl. C01B 31/02; H01M 4/62

(52) U.S. Cl. CPC C01B 31/026; H01M 4/625; C01B 2202/06; C01B 2202/24; C01B 2202/22
USPC 423/447.2; 423/447.1

(57) ABSTRACT

A method comprising adding a multi-walled carbon nanotube synthesized by the vapor phase process to a nitric acid aqueous solution of not lower than 0.2 mol/L so as to dissolve a catalyst metal present in the multi-walled carbon nanotube, performing solid-liquid separation to isolate solid matter, and subjecting the isolated solid matter to heat treatment at a temperature higher than 150° C. gives a purified multi-walled carbon nanotube in which the amount of a metallic element left in the multi-walled carbon nanotube originating the catalyst metal is not smaller than 1000 ppm and not larger than 8000 ppm determined by ICP optical emission spectrometry and the amount of an anion left in the multi-walled carbon nanotube originating in the acid is smaller than 20 ppm determined by ion chromatography analysis.

### TECHNICAL FIELD

The present invention relates to multi-walled carbon nanotubes with a low content of impurities and a purification method for obtaining the same. More specifically, the present invention relates to multi-walled carbon nanotubes synthesized by the vapor phase process and then washed with an acid, wherein the multi-walled carbon nanotubes have small amount of a metallic element derived from a catalyst metal and small amount of an anion derived from the acid, and a purification method for obtaining the same.

### BACKGROUND ART

Multi-walled carbon nanotubes are produced by chemical vapor deposition (a process in which hydrocarbons and the like are subjected to pyrolysis on a catalyst metal to form carbon nanotubes) or physical vapor deposition (a process in which graphite is sublimated by the use of arc, a laser and/or the like and, during the subsequent cooling process, carbon nanotubes are formed).

Chemical vapor deposition allows production in a larger reactor relatively easily and therefore is suitable for large-scale synthesis.

Broadly speaking, chemical vapor deposition can be performed by two methods. One is a method (the floating catalyst method) in which a metal compound as a catalyst and sulfur and/or the like as a co-catalyst are dissolved in a hydrocarbon such as benzene, and the resultant is transferred, with the use of hydrogen as a carrier gas, to a reaction field that is heated at not lower than 1000° C., followed by catalyst production and the growth of carbon nanotubes in the reaction field. The other one is a method (the supported catalyst method) in which a supported catalyst (a catalyst metal or a precursor catalyst supported on a carrier) prepared in advance is placed in a reaction field heated at 500° C. to 700° C. and, thereto, a mixed gas of a hydrocarbon such as ethylene with hydrogen, nitrogen, and/or the like is supplied, followed by a reaction.

In the floating catalyst method, the reaction is allowed to proceed at a high temperature of not lower than 1000° C., and therefore not only hydrocarbon decomposition on a catalyst metal but also a self-decomposition of a hydrocarbon proceed. Pyrolytic carbon deposits on a multi-walled carbon nanotube that has been grown on the catalyst metal, to allow further growth in the thickness direction of the fiber. The multi-walled carbon nanotube obtained by this process is covered with pyrolytic carbon having low crystallinity and therefore has relatively low electric conductivity. After the synthesis by the floating catalyst method, heat treatment is performed in an inert gas atmosphere at a temperature not lower than 2600° C. for graphitization. Such heat treatment allows rearrangement of crystal and growth of graphite crystals to proceed and, as a result, enhances the electric conductivity of the fiber. In addition, the catalyst metal evaporates due to the heat treatment to give a multi-walled carbon nanotube with a low content of impurities.

On the other hand, the supported catalyst method allows the reaction to proceed at 500 to 800° C. at which a self-decomposition reaction of hydrocarbons is suppressed, and can give a thin multi-walled carbon nanotube grown on a catalyst metal. Such a multi-walled carbon nanotube has relatively high crystallinity and relatively high electric conductivity, and therefore does not require such heat treatment, for graphitization, as performed on a multi-walled carbon nanotube obtained by the floating catalyst method. A multi-walled carbon nanotube synthesized by the supported catalyst method has not received heat treatment for the purpose of graphitization and therefore contains a catalyst metal at the order of percent remaining in the multi-walled carbon nanotube.

### PRIOR ART DOCUMENTS

### Patent Documents

Patent Document 1: JP 2002-308610 A
Patent Document 2: JP 3887315 B

### SUMMARY OF THE INVENTION

### Problems to be Solved by the Invention

Multi-walled carbon nanotubes are mainly used as a filler for rendering an electrical conductivity and/or thermal conductivity to a resin and the like. In such applications, no problem has been observed where a catalyst metal present in the product adversely affects the physical properties, such as the strength, of a resin composite.

Multi-walled carbon nanotubes that are synthesized by the floating catalyst method and have received graphitization are used as an electric conductive agent in a cathode or an anode in a lithium-ion secondary battery. On the other hand, when multi-walled carbon nanotubes that are synthesized by the supported catalyst method and have never received heat treatment are used as an electric conductive agent in a cathode (positive electrode), a phenomenon that a remaining catalyst metal ionizes in the course of repeated charging/discharging and deposits on an anode (negative electrode) occurs. When the metal deposition on an anode grows enough to pass through a separator, a cathode-anode short-circuit occurs.

For removing such a remaining metal, Patent Document 1 discloses a method for purifying a carbon nanotube characterized by immersing a carbon nanotube in an acid solution containing at least sulfuric acid so as to remove metal. Even with heat treatment at a temperature of lower than 600° C. is performed after acid washing, as described in Patent Document 1, a sulfate ion is left on the surface of the carbon nanotube. When using such a carbon nanotube in a cathode in a battery, a cathode active material might corrode due to the sulfate ion.

Patent Document 2 discloses a method for synthesizing a purified single-walled carbon nanotube with an opening at a tip of the single-walled carbon nanotube, the method characterized by comprising, in sequence, a) a step of heating, in the presence of oxidizing gas, a mixture comprising a single-walled carbon nanotube and impurities therein at a temperature adequate for selectively removing carbon impurities, b) a step of exposing the mixture to an acid at a temperature within the range of 100° C. to 130° C. so as to remove metal impurities, and c) a step of exposing the single-walled carbon nanotube to nitric acid at a temperature and for duration both of which are adequate to make the opening in the single-walled carbon nanotube. However, no detailed description is provided on the conditions for heat treatment performed after an opening is made at a tip of the single-walled carbon nanotube by nitric acid. Therefore, concern on corrosion of an electrode active material by a remaining nitrate ion is not resolved.

An object of the present invention is to provide a multi-walled carbon nanotube in which both of the amounts of a metal ion that elutes and deposits on an electrode in a battery to potentially cause a short-circuit and/or the like and of an anion that elutes to potentially corrode an electrode active material are small, and a purification method for obtaining the same.

### Means for Solving the Problems

The inventors of the present invention have conducted intensive research to achieve the object. As a result, the present invention has now been completed encompassing the embodiments below.

The present invention encompasses the following embodiments.

[1] A method for purifying a multi-walled carbon nanotube, the method comprising adding a multi-walled carbon nanotube synthesized by the vapor phase process to a nitric acid aqueous solution of not lower than 0.2 mol/L so as to dissolve a catalyst metal present in the multi-walled carbon nanotube, performing solid-liquid separation to isolate solid matter, and subjecting the solid matter to heat treatment at a temperature higher than 150° C.

[2] The purification method according to [1], further comprising adding the solid matter resulting from solid-liquid separation to pure water and performing another round of solid-liquid separation to obtain solid matter.

[3] The purification method according to [2], wherein the process of adding the solid matter resulting from solid-liquid separation to pure water and then performing another round of solid-liquid separation to isolate solid matter is repeated until the pH of the liquid resulting from solid-liquid separation reaches not lower than 1.5 and not higher than 6.0.

[4] The purification method according to any one of [1] to [3], wherein the amount of the multi-walled carbon nanotube added to the nitric acid aqueous solution is not smaller than 0.1% by mass and not larger than 5% by mass in terms of a solid content concentration.

[5] The purification method according to any one of [1] to [4], wherein the heat treatment is performed in an air atmosphere at a temperature not lower than 200° C. and lower than 350° C.

[6] The purification method according to any one of [1] to [5], wherein the dissolution of the catalyst metal present in the multi-walled carbon nanotube into the nitric acid aqueous solution is performed under atmospheric pressure.

[7] The purification method according to any one of [1] to [6], further comprising, prior to the dissolution of the catalyst metal present in the multi-walled carbon nanotube into the nitric acid aqueous solution, grinding the multi-walled carbon nanotube.

[8] A purified multi-walled carbon nanotube synthesized by the vapor phase process and then washed with an acid, wherein the amount of a metallic element left in the multi-walled carbon nanotube originating in a catalyst metal is not smaller than 1000 ppm and not larger than 8000 ppm determined by ICP optical emission spectrometry and the amount of an anion left in the multi-walled carbon nanotube originating in the acid is smaller than 20 ppm determined by ion chromatography analysis.

[9] The purified multi-walled carbon nanotube according to [8], wherein the surface layer of the multi-walled carbon nanotube is covered with amorphous carbon.

[10] An electrode for a battery, the electrode comprising the purified multi-walled carbon nanotube according to [8] or [9].

[11] A method for producing a purified multi-walled carbon nanotube, the method comprising a step of preparing a multi-walled carbon nanotube by a supported catalyst method, a step of adding the prepared multi-walled carbon nanotube to a nitric acid aqueous solution of not lower than 0.2 mol/L, a step of performing solid-liquid separation to isolate the acid-treated multi-walled carbon nanotube, and a step of subjecting the isolated multi-walled carbon nanotube to heat treatment at a temperature higher than 150° C.

### BRIEF DESCRIPTION OF THE DRAWINGS

FIG. 1 view showing a scanning electron microscope photomicrograph of one example of agglomerates of multi-walled carbon nanotubes before purification (center: by a factor of 50, upper right: by a factor of 2 k).

FIG. 2 view showing a scanning electron photomicrograph of one example of ground agglomerates of multi-walled carbon nanotubes before purification (center: by a factor of 50, upper right: by a factor of 2 k).

FIG. 3 view showing a transmission electron photomicrograph of one example of multi-walled carbon nanotubes before purification (magnification: by a factor of 500 k, the multi-walled carbon nanotube has a hollow structure and is interspersed with pyrolytic carbon on the surface).

FIG. 4 view showing a transmission electron photomicrograph of one example of multi-walled carbon nanotubes before purification (magnification: by a factor of 500 k, the multi-walled carbon nanotube has its hollow partly closed and is interspersed with pyrolytic carbon on the surface).

FIG. 5 view showing a transmission electron photomicrograph of a multi-walled carbon nanotube purified in Example 1 (magnification: by a factor of 500 k, the multi-walled carbon nanotube has a hollow structure and has disordered carbon structure uniformly on the surface).

FIG. 6 view showing a transmission electron photomicrograph of a multi-walled carbon nanotube purified in Example 1 (magnification: by a factor of 500 k, the multi-walled carbon nanotube has its hollow partly closed and has disordered carbon structure uniformly on the surface).

FIG. 7 view showing a longitudinal cross section of a cell that is used in measurement of powder resistivity.

FIG. 8 view showing a laminate used in a three-electrode cell.

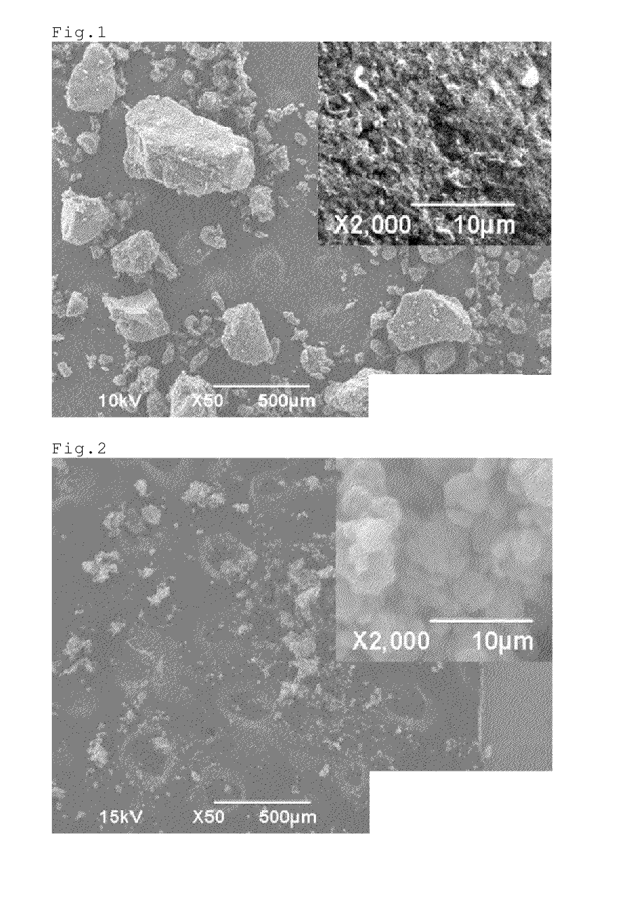

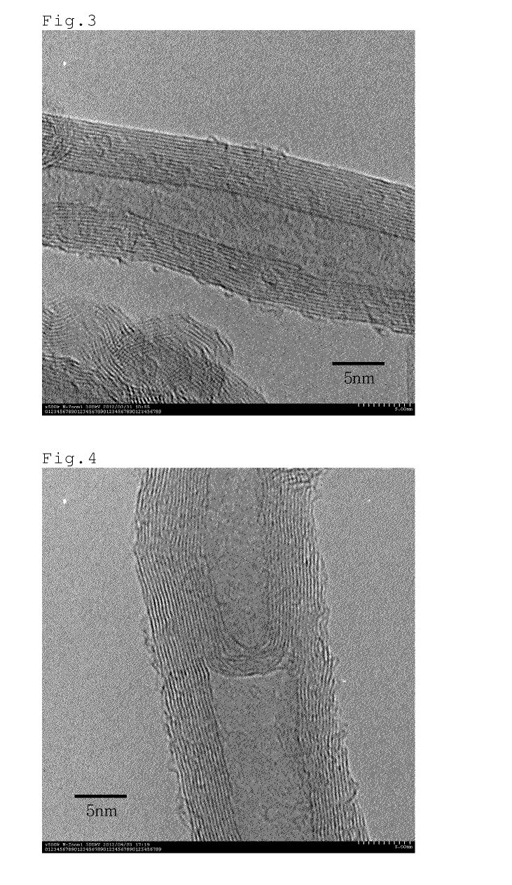

### EMBODIMENTS OF THE INVENTION

A purification method of a multi-walled carbon nanotube according to one embodiment in the present invention comprises: adding a multi-walled carbon nanotube synthesized by the vapor phase process to a nitric acid aqueous solution of not lower than 0.2 mol/L so as to dissolve a catalyst metal present in the multi-walled carbon nanotube, performing solid-liquid separation to isolate solid matter, and subjecting the isolated solid matter to heat treatment at a temperature higher than 150° C.

The multi-walled carbon nanotube used in the purification method is synthesized by the vapor phase process. In the present invention, a preferable vapor phase process is a supported catalyst method.

In the supported catalyst method, a catalyst comprising a catalyst metal supported on an inorganic carrier is used to allow a reaction of a carbon source in a gas phase so as to give a carbon fiber. Examples of the inorganic carrier include alumina, magnesia, silica-titania, calcium carbonate and the like. The inorganic carrier is preferably in powder or grain form. Examples of the catalyst metal include iron, cobalt, nickel, molybdenum, vanadium and the like. A supported catalyst can be obtained by impregnation of a carrier with a solution of a compound containing a catalyst metal element, coprecipitation of a solution containing a compound comprising a catalyst metal element and a compound comprising a constituent element composing an inorganic carrier, or another known method. Examples of the carbon source include methane, ethylene, acetylene and the like. The reaction can be performed in a reactor such as a fluidized bed reactor, a moving bed reactor, a fixed bed reactor or the like heated at 500° C. to 800° C. The carbon source can be fed into the reactor using a carrier gas. Examples of the carrier gas include hydrogen, nitrogen, argon and the like. The reaction time is preferably 5 to 120 minutes.

The multi-walled carbon nanotube used in the purification method preferably is not smaller than 6 nm and not greater than 50 nm in an outer diameter thereof and not lower than 100 and not higher than 1000 in an aspect ratio thereof. When the outer diameter of fiber is smaller than 6 nm, disentangling the fibers for dispersion is difficult, while a fiber the outer diameter of which exceeds 50 nm is difficult to prepare by the supported catalyst method. When the aspect ratio is lower than 100, an efficient electric conductive network is difficult to be formed in the prepared composite, while when the aspect ratio is higher than 1000, fibers firmly entangle to make dispersion difficult to proceed. The outer diameter of fiber and the aspect ratio are calculated by measurement of the size of the multi-walled carbon nanotube in a photomicrograph.

The multi-walled carbon nanotube synthesized by the vapor phase process may serve as it is as the multi-walled carbon nanotube for use in the purification method, and is preferably ground before being added to the nitric acid aqueous solution.

A multi-walled carbon nanotube synthesized by the vapor phase process, in particular by the supported catalyst method, generally forms an agglomerate (see FIG. 1), the size of which varies depending on the size of a catalyst to be used and is usually about 50 μm to 2 mm.

As the size of the agglomerate decreases, the agglomerate comes into contact with a washing liquid more effectively and therefore acid washing proceeds more efficiently. Examples of the method for decreasing the size of the agglomerate include the dry grinding process and the wet grinding process. Examples of an instrument to be used in dry grinding include a ball mill operated on the impact force and the shearing force of media, a pulverizer, such as a hammer mill, operated on the impact force, a jet mill operated on the collision between materials to be ground or the like. Examples of an instrument to be used in wet grinding include a bead mill operated on the shearing force of media or the like. The size of the agglomerate thus ground is preferably 1 μm to 200 μm and is more preferably 1 μm to 20 μm.

Alternatively, the multi-walled carbon nanotube that is to be purified may be oxidized by heating at not lower than 350° C. and not higher than 500° C. in the presence of oxygen such as in air. By oxidation, the water wettability of the multi-walled carbon nanotube improves to enhance the affinity of the agglomerate of the multi-walled carbon nanotubes with the nitric acid aqueous solution and, as a result, purification can proceed more effectively. Oxidation at not lower than 400° C. eliminates not multi-walled carbon nanotubes but low-crystalline amorphous carbon, and therefore the amount of metal dissolved in the nitric acid aqueous solution may increase.

In the present invention, the multi-walled carbon nanotube is added to the nitric acid aqueous solution so as to dissolve a catalyst metal present in the multi-walled carbon nanotube.

The amount of the multi-walled carbon nanotube to be added to the nitric acid aqueous solution is preferably not smaller than 0.1% by mass and not larger than 5% by mass and more preferably not smaller than 1% by mass and not larger than 4% by mass in terms of the solid content concentration.

The solid content concentration can be calculated by math formula: (mass of multi-walled carbon nanotube)/{(mass of multi-walled carbon nanotube)+(mass of nitric acid aqueous solution)}×100.

When the solid content concentration is smaller than 0.1% by mass, the amount of the multi-walled carbon nanotube treated per unit time can be low, while when the solid content concentration exceeds 5% by mass, the slurry is high in viscosity and low in fluidity and therefore can be poorly handled when transferred, stirred, and the like.

The concentration of the nitric acid aqueous solution is usually not lower than 0.2 mol/L and is preferably not lower than 0.5 mol/L and not higher than 12 mol/L. When the nitric acid aqueous solution has a concentration of lower than 0.2 mol/L, its ability to oxidize and dissolve metal tends to be lowered.

The temperature at which the catalyst metal present in the multi-walled carbon nanotube is dissolved is preferably not lower than 70° C. and not higher than the boiling point. At a temperature lower than 70° C., even though the metal can still dissolve, the process tends to take longer time. Dissolution can be allowed to proceed under atmospheric pressure. By carrying out dissolution of metal in a pressurized vessel, the temperature can be raised to 100° C. or higher and therefore the processing time can be reduced. The temperature herein is the temperature of the slurry in which the multi-walled carbon nanotube is dispersed in the nitric acid aqueous solution.

The processing time for dissolution in the nitric acid aqueous solution is not particularly limited provided that it is sufficient to dissolve the catalyst metal. When the temperature is not lower than 70° C. and not higher than the boiling point, the processing time is usually not shorter than 0.5 hours and not longer than 24 hours.

A multi-walled carbon nanotube sometimes repels a nitric acid aqueous solution and floats on the liquid surface and for this reason, after addition of the multi-walled carbon nanotube, the nitric acid aqueous solution is mixed such that the multi-walled carbon nanotube adequately comes into contact with the nitric acid aqueous solution. The method for mixing is not particularly limited, and examples thereof include using convection of the heat without forced stirring, stirring the slurry with a stirring blade, using a pump to circulate the slurry, using a jet of gas in the slurry to cause bubbling or the like. Dissolution of the catalyst metal in the nitric acid aqueous solution is preferably carried out in a vessel or an instrument lined with glass or made of corrosion-resistant material such as SUS and PTFE.

Subsequently in the present invention, solid-liquid separation is performed to isolate solid matter.

The method for the solid-liquid separation is not particularly limited. Specific examples of an instrument to be used in the solid-liquid separation include a screw press, a roller press, a rotary drum screen, a belt screen, a vibration screen, a multiple plate wave filter, a vacuum dehydrator, a pressure dehydrator, a belt press, a centrifugal concentrator-dehydrator, a multi-disc dehydrator and the like.

A cake of the solid matter resulting from the solid-liquid separation preferably has a water content ratio of lower than 91% by mass. The water content ratio is determined by formula: 100−(solid content concentration in cake (% by mass)).

Preferably, the solid matter (cake) resulting from the solid-liquid separation is added to pure water, and then the resultant is stirred for dispersion. This process allows dilution of an acid component and a dissolved metal component that are adhered to the surface of the multi-walled carbon nanotube. The solid content concentration at the time of the redispersion is preferably not smaller than 0.1% by mass and not larger than 5% by mass. After the dispersion in pure water, another round of solid-liquid separation is performed to isolate solid matter.

The process of redispersing in pure water and performing another round of solid-liquid separation for isolating solid matter is preferably repeated until the pH of the liquid resulting from solid-liquid separation reaches preferably not lower than 1.5 and not higher than 6.0 and more preferably not lower than 2.0 and not higher than 5.0. When the pH is lower than 1.5, a nitrate ion and/or dissolved metal sometimes remains at a considerable level on the surface of the multi-walled carbon nanotube. When pure water alone is used to achieve a pH higher than 6.0, the process must be repeated nearly 20 times and therefore the need for effluent treatment and the burden on the environment tend to be high.

Alternatively, at the time of filtration under reduced pressure or centrifugation, pure water can be sprayed onto the solid matter (cake) resulting from solid-liquid separation so as to substitute the acidic washing liquid present in the solid matter by the pure water.

Subsequently in the present invention, the resulting solid matter is subjected to heat treatment.

The temperature in the heat treatment is higher than 150° C. In an atmosphere containing oxygen, such as in air, the heat treatment is preferably performed at not lower than 200° C. and lower than 350° C. in order to prevent oxidation of the multi-walled carbon nanotube. In an atmosphere of inert gas such as argon and nitrogen or in a vacuum, the heat treatment can be performed at not lower than 200° C. and lower than 1300° C. By the heat treatment, water and a nitrate ion present in the solid matter are removed.

In the heat treatment, the multi-walled carbon nanotube sometimes agglomerates to become platy or the like. So, when added to an electrode or the like, the multi-walled carbon nanotube is preferably ground in a dry mill such as a pulverizer operated on the impact force of a hammer or the like and a jet mill operated on the collision between materials to be ground.

In a purified multi-walled carbon nanotube according to one embodiment in the present invention, the amount of a metallic element left in the multi-walled carbon nanotube originating in a catalyst metal is preferably not smaller than 1000 ppm and not larger than 8000 ppm and is more preferably not smaller than 1000 ppm and not larger than 6500 ppm determined by ICP optical emission spectrometry.

In a purified multi-walled carbon nanotube according to one embodiment in the present invention, the amount of an anion left in the multi-walled carbon nanotube originating in an acid is preferably smaller than 20 ppm and is more preferably smaller than 10 ppm determined by ion chromatography analysis.

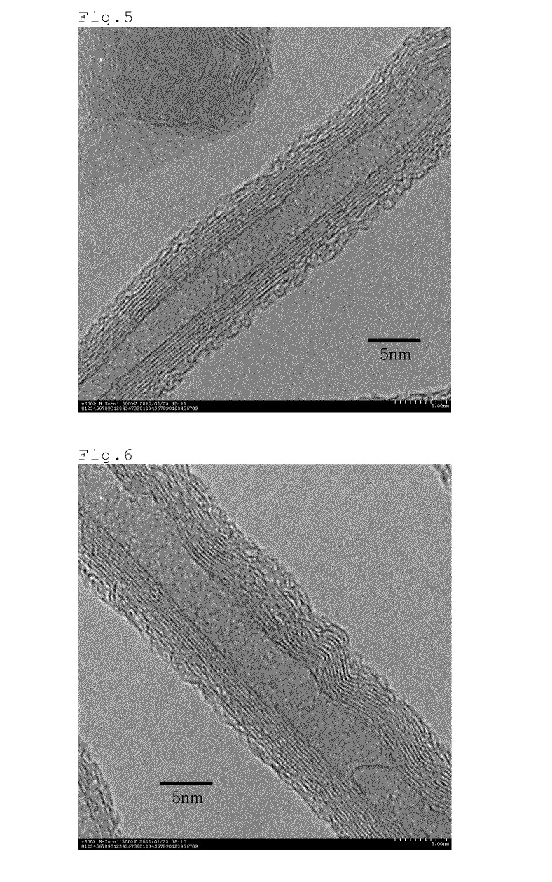

A purified multi-walled carbon nanotube according to one embodiment in the present invention has structure that is disordered uniformly on the surface layer that was once in contact with a nitric acid aqueous solution. On the other hand, the internal structure thereof remains as prior to washing and has developed crystal structure. In other words, the surface layer of a purified multi-walled carbon nanotube according to one embodiment in the present invention is covered with amorphous carbon (see FIG. 5 and FIG. 6).

A purified multi-walled carbon nanotube according to one embodiment in the present invention functions as an electric conductive agent and therefore can be suitably used in a cathode and/or an anode in a battery. A cathode for a battery can be produced of a purified multi-walled carbon nanotube according to one embodiment in the present invention, a cathode active material, and a binder. An anode for a battery can be produced of a purified multi-walled carbon nanotube according to one embodiment in the present invention, an anode active material, and a binder.

To use for the cathode active material, one, or two or more materials appropriately selected from materials conventionally known as a cathode active material in a lithium battery, wherein the materials are capable of intercalating and deintercalating a lithium ion. Among these, a lithium-containing metal oxide capable of intercalating and deintercalating a lithium ion is preferable. Examples of the lithium-containing metal oxide include complex oxides composed of the element lithium and at least one element selected from Co, Mg, Cr, Mn, Ni, Fe, Al, Mo, V, W, Ti, and the like.

To use for the anode active material, one, or two or more materials appropriately selected from materials conventionally known as an anode active material in a lithium battery, wherein the materials are capable of intercalating and deintercalating a lithium ion. Examples of the materials capable of intercalating and deintercalating a lithium ion include carbon materials, Si, Sn, and alloys and oxides containing at least one of Si and Sn. Among these, carbon materials are preferable. Typical examples of the carbon materials include natural graphite, artificial graphite resulting from heat treatment of petroleum coke and coal coke, hard carbon that is a carbonized resin, and carbon materials derived from mesophase pitch. From the viewpoint of enhancing the cell capacity, natural graphite and artificial graphite preferably have an interplanar spacing, d₀₀₂, calculated from a (002) diffraction peak resulting from X-ray powder diffraction of 0.335 to 0.337 nm. A preferable anode active material is a combination of a carbon material and any one of Si and Sn; or a combination of a carbon material and an alloy or an oxide containing at least one of Si and Sn.

For use as an electric conductive agent, the purified multi-walled carbon nanotube according to the present invention can be combined with, for example, a carbon black conductive material such as acetylene black, furnace black, and Ketjenblack.

A binder to use can be selected, as appropriate, from materials conventionally known as a binder in an electrode in a lithium battery. Examples of the binder include fluorine-containing polymers such as poly vinylidene fluoride (PVDF), vinylidene fluoride-hexafluoropropylene copolymers, vinylidene fluoride-chlorotrifluoroethylene copolymers, and vinylidene fluoride-tetrafluoroethylene copolymers; and styrene-butadiene copolymer rubber (SBR).

### EXAMPLES

The present invention will be described more specifically by examples. These examples are merely for the purpose of explanation, and the scope of the present invention is not limited to these examples.

### <Multi-Walled Carbon Nanotube>

### Production Example 1

### Preparation of Catalyst

Aluminum hydroxide (HIGILITE M-43 manufactured by Showa Denko K.K.) was subjected to heat treatment in an atmosphere with an air stream at 850° C. for 2 hours to prepare a carrier.

Into a 300-ml tall beaker, 50 g of pure water was fed and, thereto, 4.0 g of the carrier was added, followed by dispersion to prepare carrier slurry.

Into a 50-ml beaker, 16.6 g of pure water was fed and, thereto, 0.32 g of hexaammonium heptamolybdate tetrahydrate (manufactured by Junsei Chemical Co., Ltd.) was added and dissolved. Thereto, 7.23 g of iron (III) nitrate nonahydrate (manufactured by KANTO CHEMICAL CO., INC.) was added and dissolved to prepare a catalyst solution.

Into another 50-ml beaker, 32.7 g of pure water was fed and, thereto, 8.2 g of ammonium carbonate (manufactured by KANTO CHEMICAL CO., INC.) was added and dissolved to prepare a pH-adjusting solution.

A stirring bar was placed in the tall beaker containing the carrier slurry, and the tall beaker was placed on a magnetic stirrer for stirring. With the use of a pH meter to ensure the pH of the slurry being maintained at 6.0±0.1, each of the catalyst solution and the pH-adjusting solution was added dropwise to the carrier slurry with a Pasteur pipette. Addition of the entire catalyst solution to the carrier slurry took 15 minutes. The content of the tall beaker was separated with filter paper (5C), and then 50 g of pure water was sprayed onto the cake on the filter paper for washing. The cake resulting from the filtering and the washing was transferred to a ceramic dish and was then dried in a hot air dryer at 120° C. for 6 hours. The resulting dried product was ground in a mortar to prepare a catalyst for use in the synthesis of a multi-walled carbon nanotube.

### Production Example 2

### Synthesis of Multi-Walled Carbon Nanotube

The catalyst at an amount of 1.0 g obtained in Production Example 1 was placed on a quartz board, which was then placed at the center of a horizontal tube furnace (a quartz tube having an inner diameter of 50 mm, a length of 1500 mm, and a length of the soaking zone of 600 mm). With nitrogen gas introduced into the horizontal tube furnace at 500 ml/minute, the temperature was raised to 680° C. while taking time of 30 minutes. The supply of nitrogen gas was then stopped, and instead a mixed gas of ethylene and hydrogen (the ethylene concentration of 50% by volume) was introduced at 2000 ml/minute, followed by a reaction for 20 minutes to synthesize a multi-walled carbon nanotube. The supply of the mixed gas was stopped, and instead nitrogen gas was supplied, followed by cooling to room temperature. The multi-walled carbon nanotube was taken out of the furnace. The resulting multi-walled carbon nanotube included many agglomerates with a particle diameter of 50 to 600 μm.

The multi-walled carbon nanotube had a specific surface area of 260 m²/g and powder resistivity of 0.016 Ω2 cm. The metals contained in the multi-walled carbon nanotube were 11200 ppm of iron and 2000 ppm of molybdenum.

### Production Example 3

### Grinding of Multi-Walled Carbon Nanotube

The multi-walled carbon nanotube synthesized in Production Example 2 was ground in Jet Mill STJ-200 manufactured by Seishin Enterprise Co, Ltd. under conditions of pressure at the pusher nozzle of 0.64 MPa and pressure at the grinding nozzle of 0.60 MPa. The ground multi-walled carbon nanotube was formed of agglomerates with a 50% particle size, D₅₀, of 6 μm in a volume-based cumulative particle size distribution.

The ground multi-walled carbon nanotube had a specific surface area of 260 m²/g and powder resistivity of 0.018 Ωcm. The metals contained in the ground multi-walled carbon nanotube were 11200 ppm of iron and 2000 ppm of molybdenum.

### <Chemicals and the Like Used in Examples>

Nitric acid: nitric acid (concentration: 60 to 61%), a reagent manufactured by KANTO CHEMICAL CO., INC., used after dilution with pure water

Hydrochloric acid: hydrochloric acid (concentration: 35.0 to 37.0%), a reagent manufactured by KANTO CHEMICAL CO., INC., used after dilution with pure water

Sulfuric acid: 3 mol %-sulfuric acid, a reagent manufactured by KANTO CHEMICAL CO., INC., used after dilution with pure water

Pure water: produced by using Ultrapure Water System RFU424TA (water quality: 18.2 Ωcm (25° C.)) manufactured by ADVANTEC

### <Analysis Method>

### (Specific Surface Area)

A specific surface area analyzer (NOVA1000 manufactured by Yuasa-Ionics Company, Limited) and nitrogen gas were used in measurement.

### (Powder Resistivity)

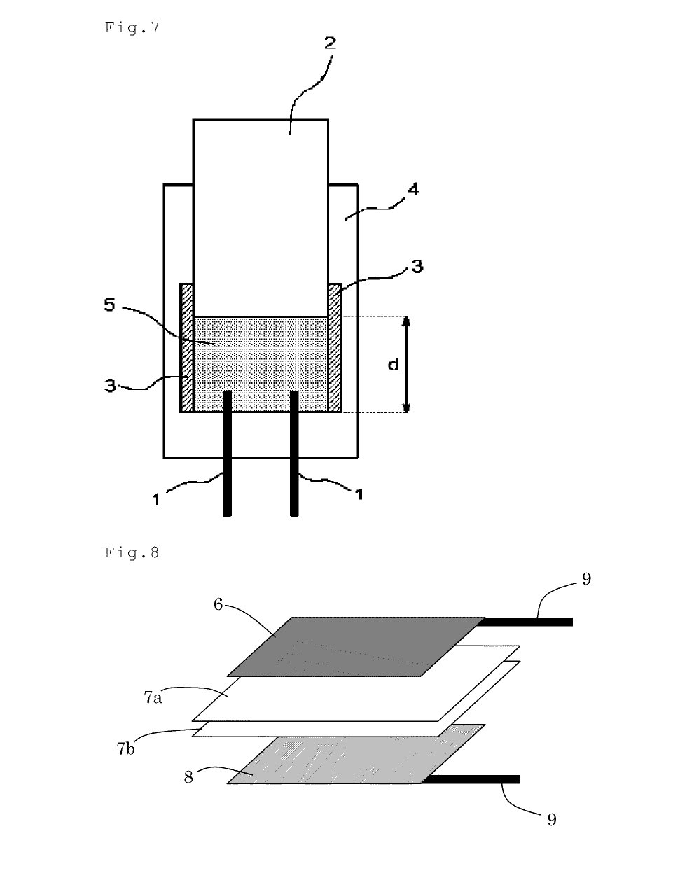

A measuring jig shown in FIG. 7 was used. Cell 4, made of resin and having an inside dimension of 4-cm wide×1-cm deep×10-cm high, had copper plate current terminal 3 for passing a current through subject material 5 and voltage measuring terminal 1 in the middle thereof. In cell 4, a certain amount of sample was placed, which was then compressed from above by force applied to compression rod 2. A current of 0.1 A was passed through the sample, and when the bulk density reached 0.8 g/cm³, the voltage in the gap of 2.0 cm between two voltage measuring terminals 1 inserted from the bottom of the vessel was read, followed by calculation of resistivity, R, by formula:

R=(voltage/current)×(cross-sectional area/distance between terminals)=(E/0.1)×(D/2).

In the formula, cross-sectional area D in current direction=height×depth of compressed sample=d×1 (cm²), E denotes the voltage [V] between the terminals, and R denotes resistivity [Ωcm].

The resistivity changes depending on pressure conditions. The resistivity is high at low pressure, decreases as the pressure increases, and becomes approximately constant at certain pressure or higher. In examples, resistivity as of when the compression achieved bulk density of 0.8 g/cm³ was used as compression resistivity.

### (Concentration of Metal in Multi-Walled Carbon Nanotube)

A sample at an amount of 20 to 40 mg and then 2 ml of sulfuric acid were fed into a fluororesin beaker, on which a fluororesin watch glass was then placed. The resultant was heated for 30 minutes on a ceramic heater set at 300° C., and was then left to cool for about 5 minutes. To the resultant, 0.5 ml of nitric acid was added, followed by heating. The process of adding nitric acid, heating, and leaving to cool was repeated until the content apparently disappeared. After cooling to room temperature, about 20 ml of pure water and 0.5 ml of 50%-hydrofluoric acid were added, followed by heating on a hot plate at 60 to 70° C. for 2 hours. The content of the beaker was transferred to a polypropylene vessel and was then diluted to achieve 50 ml, followed by quantification of iron and molybdenum by an ICP optical emission spectrometer (Vista-PRO manufactured by SII NanoTechnology Inc.).

### (Concentration of Anion in Multi-Walled Carbon Nanotube)

A sample at an amount of about 0.2 g and then 10 ml of pure water were fed into a vial container, followed by sonication for 10 minutes. The resultant was then left for 48 hours. Subsequently, 10-fold dilution was performed with pure water that had been filtered with a 0.2-μm syringe filter, followed by measurement of anion in the liquid by an ion chromatograph (ICS-2000 manufactured by Dionex Corporation) and conversion of the resultant value into the mass concentration in the sample.

### (Measurement of Particle Size)

A sample at an amount of 0.007 g was placed in a beaker containing 20 ml of pure water and, to the beaker, 0.2 g of diluted Triton (diluted 100-fold with pure water) was added dropwise. The beaker was subjected to treatment with an ultrasonic disperser for 5 minutes. Subsequently, 30 ml of pure water was added to the beaker, which was subjected to treatment with an ultrasonic disperser for another 3 minutes. The particle size for the dispersion was measured by Microtrac HRA manufactured by Nikkiso Co., Ltd.

(Measurement of pH of Liquid Resulting from Solid-Liquid Separation)

The liquid left in a suction bottle after solid-liquid separation was transferred to a 2-liter beaker. A stirring bar was placed in the beaker, which was then placed on a magnetic stirrer. With stirring, the pH was measured with a pH meter (pH72) manufactured by Yokogawa Electric Corporation.

(Concentration of Metal in Liquid Resulting from Solid-Liquid Separation)

The amounts of iron and molybdenum in the liquid resulting from solid-liquid separation were determined by an ICP optical emission spectrometer (ICPE-9000 manufactured by Shimadzu Corporation).

### (Observation by Scanning Electron Microscope)

A sample in powder form was adhered to a carbon tape and then to gold vapor deposition so as to give a specimen, followed by observation by JSM-6390 manufactured by JEOL Ltd.

### (Observation by Transmission Electron Microscope)

A small amount of a sample in powder form was added to ethanol, followed by sonication for dispersion. The resultant was put onto a carbon microgrid (having a support film) to give a specimen, which was subjected to observation by 9500 manufactured by Hitachi, Ltd.

### (Solid Content Concentration Measurement)

About 1 g of solid matter (cake) resulting from solid-liquid separation was weighed on a watch glass the tare of which had been measured, and the watch glass was placed in a hot-air dryer maintained at 150° C., followed by heat treatment for 3 hours. After the heat treatment, the watch glass and the solid matter taken out of the hot-air dryer were placed in a desiccator containing silica gel and were left for 30 minutes, followed by cooling to room temperature. After cooling, the mass of the watch glass and the solid matter was measured. The solid content concentration was calculated by formula:

solid content concentration (% by mass)=(mass of solid matter after drying)/(mass of solid matter before drying)×100

### Example 1

### Acid Washing

A separable flask (2 L in volume) containing 990 g of a 0.5-mol/L nitric acid aqueous solution and a stirring bar was placed on a hot stirrer, and 10 g of the multi-walled carbon nanotube obtained in Production Example 3 was added thereto while the nitric acid aqueous solution was stirred. Subsequently, the separable flask was fitted with a separable jacket equipped with a thermometer and a condenser. Heating of the hot stirrer was started to raise the temperature of the slurry to 90° C. while taking time of about 40 minutes and then to maintain the temperature at not lower than 90° C. for 3 hours. The temperature of the slurry at the completion of the acid washing was 98° C.

### (Solid-Liquid Separation)

The separable flask was removed from the hot stirrer and was then placed in a water bath for cooling. The slurry thus cooled to 40° C. was filtered under reduced pressure, which was achieved by an aspirator, with the use of a Nutsche having filter paper (5C) therein. The filtration was stopped when the solid matter cake on the filter paper started to crack and the reduced pressure (−750 mmHg) shifted to nearly atmospheric pressure (−150 mmHg). The solid content concentration then was 10% by mass. The pH of the filtrate was measured with a pH meter, while the concentration of metal in the filtrate was measured by an ICP optical emission spectrometer. The results are shown in Table 1.

### (Redispersion in Pure Water—Another Round of Solid-Liquid Separation)

The solid matter was added to a beaker (2 L in volume) containing 1500 g of pure water and a stirring bar, followed by stirring with a magnetic stirrer for 30 minutes to give slurry. The slurry was subjected to filtration in the same manner as the solid-liquid separation above.

This process was repeated 5 times. Each time, the pH of the filtrate was measured with a pH meter, while the concentration of metal in the filtrate was measured by an ICP optical emission spectrometer. The results are shown in Table 1.

TABLE 1

| | |
|---|---|
| | Metal concentration |
| pH of | of filtrate [ppm] |

| | filtrate | Fe | Mo |
|---|---|---|---|
| Filtrate after | 0.7 | 47.2 | 7.63 |
| acid washing | | | |
| Filtrate after | 1.4 | 2.24 | 0.25 |
| 1st redispersion | | | |
| in pure water | | | |
| Filtrate after | 2.7 | 0.10 | Below |
| 2nd redispersion | | | detection |
| in pure water | | | limit |
| Filtrate after | 3.6 | Below | Below |
| 3rd redispersion | | detection | detection |
| in pure water | | limit | limit |
| Filtrate after | 4.0 | Below | Below |
| 4th redispersion | | detection | detection |
| in pure water | | limit | limit |
| Filtrate after | 4.4 | Below | Below |
| 5th redispersion | | detection | detection |
| in pure water | | limit | limit |

### (Heat Treatment)

The resulting solid matter was placed on a ceramic dish and was then dried in a hot-air dryer set at 200° C. for 9 hours to give a purified multi-walled carbon nanotube. The content of impurities in the purified multi-walled carbon nanotube was shown in Table 2.

### Example 2

A purified multi-walled carbon nanotube was obtained in the same manner as in Example 1 except that the method of heat treatment in Example 1 was changed to a method to be described below. The content of impurities in the purified multi-walled carbon nanotube was shown in Table 2.

The solid matter was placed on a glass boat, which was then placed in a horizontal tube furnace (a quartz tube having an inner diameter of 50 mm, a length of 1500 mm, and a length of the soaking zone of 600 mm). In an argon stream, the temperature was raised from room temperature to 400° C. while taking time of 1 hour and was then maintained at 400° C. for 3 hours. The furnace was left to cool until the temperature thereof reached 200° C. or below. The argon stream was stopped, and the glass boat was recovered.

### Comparative Example 1

A purified multi-walled carbon nanotube was obtained in the same manner as in Example 1 except that the preset temperature of the hot-air dryer during heat treatment was changed to 100° C. The content of impurities in the purified multi-walled carbon nanotube was shown in Table 2.

### Comparative Example 2

A purified multi-walled carbon nanotube was obtained in the same manner as in Example 1 except that the preset temperature of the hot-air dryer during heat treatment was changed to 150° C. The content of impurities in the purified multi-walled carbon nanotube was shown in Table 2.

### Comparative Example 3

A purified multi-walled carbon nanotube was obtained in the same manner as in Comparative Example 2 except that a 1-mol/L hydrochloric acid aqueous solution was used instead of a 0.5-mol/L nitric acid aqueous solution. The temperature of the slurry at the completion of acid washing was 98° C. The content of impurities in the purified multi-walled carbon nanotube was shown in Table 2.

### Comparative Example 4

A purified multi-walled carbon nanotube was obtained in the same manner as in Example 2 except that a 1-mol/L hydrochloric acid aqueous solution was used instead of a 0.5-mol/L nitric acid aqueous solution. The temperature of the slurry at the completion of acid washing was 98° C. The content of impurities in the purified multi-walled carbon nanotube was shown in Table 2.

### Comparative Example 5

A purified multi-walled carbon nanotube was obtained in the same manner as in Comparative Example 2 except that a 0.5-mol/L sulfuric acid aqueous solution was used instead of a 0.5-mol/L nitric acid aqueous solution. The temperature of the slurry at the completion of acid washing was 98° C. The content of impurities in the purified multi-walled carbon nanotube was shown in Table 2.

### Comparative Example 6

A purified multi-walled carbon nanotube was obtained in the same manner as in Example 2 except that a 0.5-mol/L sulfuric acid aqueous solution was used instead of a 0.5-mol/L nitric acid aqueous solution. The temperature of the slurry at the completion of acid washing was 98° C. The content of impurities in the purified multi-walled carbon nanotube was shown in Table 2.

TABLE 2

| | | | pH of | | | | | |
|---|---|---|---|---|---|---|---|---|
| | Acid | | Filtrate | Heat treatment | | Impurities in multi- | | |
| | | Concen- | after 5th | conditions | | walled carbon nanotube | | |
| | | tration | redispersion | Atmos- | Temper- | Fe | Mo | Anion |
| | Type | [mol/L] | in pure water | phere | ature | [ppm] | [ppm] | [ppm] |
| Ex. 1 | Nitric | 0.5 | 4.4 | Air | 200° C. | 5,300 | 1,000 | 5 |
| | acid | | | | | | | |
| Ex. 2 | Nitric | 0.5 | 4.4 | Argon | 400° C. | 5,300 | 1,000 | Below |
| | acid | | | | | | | detection |
| | | | | | | | | limit |
| Comp. | Nitric | 0.5 | 4.4 | Air | 100° C. | 5,300 | 1,000 | 500 |
| Ex. 1 | acid | | | | | | | |
| Comp. | Nitric | 0.5 | 4.4 | Air | 150° C. | 5,300 | 1,000 | 150 |
| Ex. 2 | acid | | | | | | | |
| Comp. | Hydro- | 1.0 | 4.3 | Air | 150° C. | 6,300 | 920 | 330 |
| Ex. 3 | chloric | | | | | | | |
| | acid | | | | | | | |
| Comp. | Hydro- | 1.0 | 4.3 | Argon | 400° C. | 6,300 | 920 | 160 |
| Ex. 4 | chloric | | | | | | | |
| | acid | | | | | | | |
| Comp. | Sulfuric | 0.5 | 4.1 | Air | 150° C. | 7,000 | 880 | 760 |
| Ex. 5 | acid | | | | | | | |
| Comp. | Sulfuric | 0.5 | 4.1 | Argon | 400° C. | 7,000 | 880 | 340 |
| Ex. 6 | acid | | | | | | | |

### Example 3

A purified multi-walled carbon nanotube was obtained in the same manner as in Example 1 except that a 0.25-mol/L nitric acid aqueous solution was used instead of a 0.5-mol/L nitric acid aqueous solution. The temperature of the slurry at the completion of acid washing was 98° C. The content of impurities in and the powder resistivity of the purified multi-walled carbon nanotube were shown in Table 3.

### Example 4

A purified multi-walled carbon nanotube was obtained in the same manner as in Example 1 except that 980 g of a 1-mol/L nitric acid aqueous solution was used instead of 990 g of a 0.5-mol/L nitric acid aqueous solution and the amount of the multi-walled carbon nanotube was changed from 10 g to 20 g. The temperature of the slurry at the completion of acid washing was 98° C. The content of impurities in and the powder resistivity of the purified multi-walled carbon nanotube were shown in Table 3.

### Example 5

A purified multi-walled carbon nanotube was obtained in the same manner as in Example 1 except that the method of acid washing in Example 1 was changed to the following one.

To a separable flask (2 L in volume) containing 960 g of a 3-mol/L nitric acid aqueous solution, a Three-one motor was fitted and, while the nitric acid aqueous solution was stirred, 40 g of the multi-walled carbon nanotube obtained in Production Example 2 was added. Subsequently, the Three-one motor was removed, and the separable flask was fitted with a separable jacket equipped with a thermometer and a condenser. A mantle heater was attached to the bottom of the separable flask, and heating of the mantle heater was started to raise the temperature of the slurry to 90° C. while taking time of about 40 minutes and then to maintain the temperature at not lower than 90° C. for 3 hours. The temperature of the slurry at the completion of the acid washing was 102° C. The content of impurities in and the powder resistivity of the purified multi-walled carbon nanotube were shown in Table 3.

### Example 6

A purified multi-walled carbon nanotube was obtained in the same manner as in Example 1 except that a 6-mol/L nitric acid aqueous solution was used instead of a 0.5-mol/L nitric acid aqueous solution. The temperature of the slurry at the completion of acid washing was 105° C. The content of impurities in and the powder resistivity of the purified multi-walled carbon nanotube were shown in Table 3.

### Comparative Example 7

A purified multi-walled carbon nanotube was obtained in the same manner as in Example 1 except that a 0.1-mol/L nitric acid aqueous solution was used instead of a 0.5-mol/L nitric acid aqueous solution. The temperature of the slurry at the completion of acid washing was 98° C. The content of impurities in and the powder resistivity of the purified multi-walled carbon nanotube were shown in Table 3.

TABLE 3

| | | | | Multi-walled carbon nanotube | | | | |
|---|---|---|---|---|---|---|---|---|
| | | | Solid | | | | Physical properties | |
| | Acid | | content | | | | of powder | |
| | | Concen- | concen- | Impurities | | | Specific | Powder |
| | | tration | tration | (ppm) | | | surface | resistivity |
| | Type | [mol/L] | [mass %] | Fe | Mo | Anion | area [m²/g] | [Ωcm] |
| Ex. 3 | Nitric acid | 0.25 | 1 | 6,700 | 1,300 | 5 | 265 | 0.020 |
| Ex. 4 | Nitric acid | 1.00 | 2 | 4,800 | 780 | 5 | 275 | 0.023 |
| Ex. 5 | Nitric acid | 3.00 | 4 | 4,400 | 670 | 5 | 290 | 0.027 |
| Ex. 6 | Nitric acid | 6.00 | 1 | 3,200 | 420 | 5 | 300 | 0.038 |
| Comp. Ex. 7 | Nitric acid | 0.10 | 1 | 7,100 | 1,500 | 5 | 260 | 0.018 |

The methods for preparing, testing, and analyzing an electrode for evaluation purpose and a cell for evaluation purpose are shown below.

### <Preparation of Composite Electrode of Multi-Walled Carbon Nanotube/PTFE>

A purified multi-walled carbon nanotube at an amount of 1.6 g (W1) and 0.4 g of PTFE were weighed and placed in an agate mortar, followed by mixing with a pestle to uniformity. Mixing was continued intensely so as to stretch the PTFE and, as a result, a rubbery multi-walled carbon nanotube/PTFE composite was obtained.

The resulting composite was cut into a predetermined size (20 mm×20 mm×0.5 mmt) and was then pressed at pressure of 15 MPa with a hydraulic uniaxial press into adherence to an aluminum mesh (20 mm×20 mm×0.03 mmt) to which an aluminum tab lead had been welded, to give a composite electrode of multi-walled carbon nanotube/PTFE.

### <Preparation of Cell for Evaluation Purpose>

Cell preparation, cell disassembling, and dissolution of an counter electrode in ethanol were performed in a dry argon atmosphere at a dew point of not higher than −80° C.

FIG. 8 is a schematic view of a laminate in a three-electrode cell. The multi-walled carbon nanotube/PTFE composite electrode as working electrode 6 and lithium metal foil 8 (counter electrode: manufactured by Honjo Metal Co., Ltd., 22 mm×22 mm×0.05 mmt) that had been pressure-bonded to a copper mesh were laminated with two separators 7a and 7b (Celgard #2400 manufactured by Celgard Corporation, 30 mm×50 mm×0.025 mmt) sandwiched between the electrode 6 and the foil 8. The resulting laminate was inserted into aluminum laminate material that had been heat-sealed at its two sides, and to the resultant, tab lead 9 was bonded by heat sealing to prepare a three-electrode cell. Into the three-electrode cell, an electrolytic solution was injected, followed by vacuum heat sealing to give a cell for evaluation purpose.

The electrolytic solution was a mixture of 8 parts by mass of EC (ethylene carbonate) and 12 parts by mass of EMC (ethyl methyl carbonate) and contained 1.0 mol/liter of LiPF₆ dissolved therein as an electrolyte.

### <Method for Testing Metal Elution>

The cell for evaluation purpose was connected to Potentiostat/Galvanostat (manufactured by Biologic Science instruments), and a voltage of 4.3 V against the reference electrode was applied to the working electrode. The voltage was maintained until the current adequately decayed (24 hours). Due to the voltage applied, the metal contained in the multi-walled carbon nanotube/PTFE composite electrode was eluted into the electrolytic solution as an ion and was reduced on the lithium metal foil that served as the counter electrode, thereby deposited as metal.

### <Method for Analyzing Amount of Metal Elution>

After the completion of the test, the cell for evaluation purpose was disassembled with a cutter to take out the opposite electrode (lithium metal foil), the mass of which was then measured (W1). The counter electrode was immersed in ethanol in an inert gas atmosphere for dissolution. The resulting ethanol solution was heated to remove ethanol, and the entire residue was dissolved in a mixed acid. The resulting residue solution was subjected to analysis by an ICP optical emission spectrometer (Vista-PRO manufactured by SII NanoTechnology Inc.) to quantify Fe and Mo contained therein (W2 and W2′). As a reference, the metal lithium (W3) alone, unused, was subjected to analysis by an ICP optical emission spectrometer (Vista-PRO manufactured by SII NanoTechnology Inc.) to quantify Fe and Mo contained therein (Wr and Wr′). The amounts [ppm] of Fe and Mo eluted and deposited were calculated by formulae (1) and (2):

Amount of Fe eluted [ppm]={(W2/W1)−(Wr/W3)}×1000000 (1)

Amount of Mo eluted [ppm]={(W2′/W1)−(Wr′/W3)}×1000000 (2).

### Example 7

The purified multi-walled carbon nanotube obtained in Example 4 was ground in a juicer mixer (Fiber Mixer MX-X57 manufactured by Panasonic Corporation) for 1 minute. The resultant was then mixed with PTFE to prepare a multi-walled carbon nanotube/PTFE composite electrode and a cell for evaluation purpose, followed by testing metal elution. The results are shown in Table 4.

### Comparative Example 8

A multi-walled carbon nanotube/PTFE composite electrode and a cell for evaluation purpose were prepared in the same manner as in Example 7 except that the purified multi-walled carbon nanotube obtained in Comparative Example 3 was used instead of the purified multi-walled carbon nanotube obtained in Example 4, followed by testing metal elution. The results are shown in Table 4.

### Comparative Example 9

A multi-walled carbon nanotube/PTFE composite electrode and a cell for evaluation purpose were prepared in the same manner as in Example 7 except that the purified multi-walled carbon nanotube obtained in Comparative Example 7 was used instead of the purified multi-walled carbon nanotube obtained in Example 4, followed by testing metal elution. The results are shown in Table 4.

TABLE 4

| | |
|---|---|
| | Electrochemical |
| Acid | metal elution |

| | | Concentration | Fe | Mo |
|---|---|---|---|---|
| | Type | [mol/L] | [ppm] | [ppm] |
| Ex. 7 | Nitric acid | 1.0 | 16 | 16 |
| Comp. | Hydrochloric | 1.0 | 72 | 32 |
| Ex. 8 | acid | | | |
| Comp. | Nitric acid | 0.1 | 96 | 32 |
| Ex. 9 | | | | |

### EXPLANATION OF SYMBOLS

1: voltage measuring terminal
2: compression rod
3: copper plate current terminal
4: resin cell
5: subject material
6: working electrode (composite electrode of multi-walled carbon nanotube/PTFE)
7a and 7b: separators (two sheets)
8: counter electrode (lithium metal foil pressure bonded to copper mesh)
9: tab lead

1. A method for purifying a multi-walled carbon nanotube, the method comprising:
adding a multi-walled carbon nanotube synthesized by a vapor phase process to a nitric acid aqueous solution of not lower than 0.2 mol/L so as to dissolve a catalyst metal present in the multi-walled carbon nanotube,
performing solid-liquid separation to isolate solid matter, and
subjecting the solid matter to heat treatment at a temperature higher than 150° C.

2. The purification method according to claim 1, further comprising adding the solid matter resulting from solid-liquid separation to pure water and performing another round of solid-liquid separation to isolate solid matter.

3. The purification method according to claim 2, wherein the process of adding the solid matter resulting from solid-liquid separation to pure water and then performing another round of solid-liquid separation to isolate solid matter is repeated until the pH of the liquid resulting from solid-liquid separation reaches not lower than 1.5 and not higher than 6.0.

4. The purification method according to claim 1, wherein the amount of the multi-walled carbon nanotube added to the nitric acid aqueous solution is not smaller than 0.1% by mass and not larger than 5% by mass in terms of a solid content concentration.

5. The purification method according to claim 1, wherein the heat treatment is performed in an air atmosphere at a temperature not lower than 200° C. and lower than 350° C.

6. The purification method according to claim 1, wherein the dissolution of the catalyst metal present in the multi-walled carbon nanotube into the nitric acid aqueous solution is performed under atmospheric pressure.

7. The purification method according to claim 1, further comprising, prior to the dissolution of the catalyst metal present in the multi-walled carbon nanotube into the nitric acid aqueous solution, grinding the multi-walled carbon nanotube.

8. A purified multi-walled carbon nanotube synthesized by a vapor phase process and then washed with an acid, wherein the amount of a metallic element left in the multi-walled carbon nanotube originating in a catalyst metal is not smaller than 1000 ppm and not larger than 8000 ppm determined by ICP optical emission spectrometry and the amount of an anion left in the multi-walled carbon nanotube originating in the acid is smaller than 20 ppm determined by ion chromatography analysis.

9. The purified multi-walled carbon nanotube according to claim 8, wherein the surface layer of the multi-walled carbon nanotube is covered with amorphous carbon.

10. An electrode for a battery, the electrode comprising the purified multi-walled carbon nanotube according to claim 8.

11. A method for producing a purified multi-walled carbon nanotube, the method comprising
a step of preparing a multi-walled carbon nanotube by a supported catalyst method,
a step of adding the prepared multi-walled carbon nanotube to a nitric acid aqueous solution of not lower than 0.2 mol/L,
a step of performing solid-liquid separation to isolate the acid-treated multi-walled carbon nanotube, and
a step of subjecting the isolated multi-walled carbon nanotube to heat treatment at a temperature higher than 150° C.
